(19) United States
(12) Patent Application Publication
(10) Pub. No.: US 2021/0179487 A1
(43) Pub. Date: Jun. 17, 2021

(54) COVER WINDOW AND DISPLAY DEVICE INCLUDING THE SAME

(71) Applicant: Samsung Display Co., LTD., Yongin-si (KR)

(72) Inventors: Sang Hoon KIM, Hwaseong-si (KR); Seong Jin HWANG, Suwon-si (KR); Jae Sung KIM, Suwon-si (KR); Koan Duck SEO, Incheon (KR); Min Sang KOO, Seongnam-si (KR); Kyung-Man KIM, Anyang-si (KR); Yun Ho KIM, Seoul (KR); Chang Ho CHO, Incheon (KR); Min-Hoon CHOI, Seoul (KR)

(21) Appl. No.: 16/937,633

(22) Filed: Jul. 24, 2020

(30) Foreign Application Priority Data
Dec. 16, 2019 (KR) 10-2019-0167546

(51) Int. Cl. C03C 17/32; C09D 5/00; C09D 163/00; G02B 1/14

(52) U.S. Cl. CPC C03C 17/326; C09D 5/002; C03C 2217/78; G02B 1/14; C03C 2218/151; C09D 163/00

(57) ABSTRACT

A cover window according to an exemplary embodiment includes a glass substrate, and a first coating layer disposed on a first major surface of the glass substrate, where the first coating layer includes an epoxy silane and an oligomer, and an average molecular weight of the oligomer is about 300 g/mol to about 5000 g/mol.

This application claims priority to Korean Patent Application No. 10-2019-0167546, filed on Dec. 16, 2019, and all the benefits accruing therefrom under 35 U.S.C. § 119, the content of which in its entirety is herein incorporated by reference.

### BACKGROUND

### (a) Technical Field

The present disclosure relates to a cover window and a display device including the same.

### (b) Description of the Related Art

Various mobile electronic apparatuses, such as a portable phone, a navigation device, a digital camera, an electronic book, and a portable game console, and various kinds of terminals to which a liquid crystal display device or an organic light emitting diode display device is applied as a display device, have been used.

In general, the display device includes a display panel, and a cover window configured to be transparent so that a user may watch a display unit through the cover window is provided on a front of the display panel.

The above information disclosed in this Background section is only for enhancement of understanding of the background of the invention and therefore it may contain information that does not form the prior art that is already known in this country to a person of ordinary skill in the art.

### SUMMARY

The cover window may be a component configured at the outermost major surface of a display device, which is, thus, required to be resistant to external impact to protect a display panel, and the like, within the display device.

Further, research on a flexible display device has been actively conducted, and it is preferable that a cover window applied to such a display device is formed to have flexibility.

The invention has been made in an effort to provide a cover window which may be bent and of which impact resistance is reinforced, and a display device including the same.

An exemplary embodiment of the invention provides a cover window including a glass substrate, and a first coating layer disposed on a first major surface of the glass substrate, where the first coating layer includes an epoxy silane and an oligomer, and an average molecular weight of the oligomer is about 300 grams per mol (g/mol) to about 5000 g/mol.

In an exemplary embodiment, the average molecular weight of the oligomer may be about 330 g/mol to about 2000 g/mol.

In an exemplary embodiment, a thickness of the glass substrate may be 10 to 100 micrometers (μm).

In an exemplary embodiment, the oligomer may include a polyimine oligomer.

In an exemplary embodiment, the oligomer may include an epoxy oligomer or an acryl oligomer.

In an exemplary embodiment, a thickness of the first coating layer may be 50 to 1000 angstroms (Å).

In an exemplary embodiment, the oligomer may be linear.

In an exemplary embodiment, the oligomer may include an aromatic ring.

In an exemplary embodiment, the first coating layer may have a constant thickness.

In an exemplary embodiment, the first coating layer may have a concave and convex shape including a plurality of protrusions.

In an exemplary embodiment, the cover window may further include a second coating layer disposed on a second major surface facing the first major surface of the glass substrate, where the second coating layer includes an epoxy silane and an oligomer, and an average molecular weight of the oligomer is about 300 g/mol to about 5000 g/mol.

Another exemplary embodiment of the invention provides a display device including a display panel, and a cover window disposed on the display panel, where the cover window includes a glass substrate and a first coating layer disposed on a first major surface of the glass substrate, the first coating layer includes an epoxy silane and an oligomer, and an average molecular weight of the oligomer is about 300 g/mol to about 5000 g/mol.

In an exemplary embodiment, the average molecular weight of the oligomer may be about 330 g/mol to about 2000 g/mol.

In an exemplary embodiment, a thickness of the glass substrate may be 10 to 100 μM.

In an exemplary embodiment, the oligomer may include a polyimine oligomer.

In an exemplary embodiment, the oligomer may include an epoxy oligomer or an acryl oligomer.

In an exemplary embodiment, a thickness of the first coating layer may be 50 to 1000 Å.

In an exemplary embodiment, the cover window may further include a second coating layer disposed on a second major surface facing the first major surface of the glass substrate, the second coating layer may include an epoxy silane and an oligomer, and an average molecular weight of the oligomer is about 300 g/mol to about 5000 g/mol.

In an exemplary embodiment, the first coating layer may have a constant thickness, and the second coating layer may have a concave and convex shape including a plurality of protrusions.

In an exemplary embodiment, the first coating layer and the second coating layer may include different materials from each other.

According to the exemplary embodiments, the cover window and the display device including the same may be folded and may reinforce the impact resistance.

### BRIEF DESCRIPTION OF THE DRAWINGS

FIG. 1 shows a cross-sectional view of a cover window according to an exemplary embodiment.

FIG. 2 shows a cross-sectional view of a display device according to an exemplary embodiment.

FIG. 3 shows a graph of a height limit of a free fall of a pen into a cover window according to a comparative example and exemplary embodiments.

FIG. 4 shows a graph of a height limit of a free fall of a pen into a cover window according to a thickness of a coating layer.

FIG. 5 shows a cross-sectional view of a cover window according to another exemplary embodiment.

FIG. 6 shows a cross-sectional view of a cover window according to still another exemplary embodiment.

FIG. 7 shows a cross-sectional view of a cover window according to yet another exemplary embodiment.

FIG. 8 shows a cross-sectional view of a cover window according to still another exemplary embodiment.

FIG. 9 shows a cross-sectional view of a cover window according to yet another exemplary embodiment.

FIG. 10 shows a cross-sectional view of a cover window according to still another exemplary embodiment.

FIG. 11 shows a cross-sectional view of a cover window according to yet another exemplary embodiment.

### DETAILED DESCRIPTION

The invention will be described more fully hereinafter with reference to the accompanying drawings, in which exemplary embodiments of the invention are shown. As those skilled in the art would realize, the described exemplary embodiments may be modified in various different ways, all without departing from the spirit or scope of the present invention.

The drawings and description are to be regarded as illustrative in nature and not restrictive, and like reference numerals designate like elements throughout the specification.

Further, the size and thickness of each configuration shown in the drawings are arbitrarily shown for better understanding and ease of description, and the present invention is not limited thereto. In the drawings, the thickness of layers, films, panels, regions, etc., are exaggerated for clarity. For better understanding and ease of description, the thicknesses of some layers and areas are exaggerated.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, the word “on” or “above” means positioned on or below the object portion, and does not necessarily mean positioned on the upper major surface of the object portion based on a gravitational direction.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless explicitly described to the contrary, the word “comprise” and variations such as “comprises” or “comprising” will be understood to imply the inclusion of stated elements but not the exclusion of any other elements.

The phrase “on a plane” means viewing the object portion from the top, and the phrase “on a cross-section” means viewing a cross-section of which the object portion is vertically cut from the side.

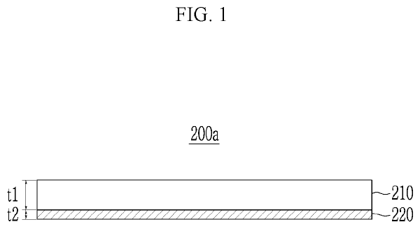

A cover window according to an exemplary embodiment will now be described with reference to FIG. 1. FIG. 1 shows a cross-sectional view of a cover window according to an exemplary embodiment. The cover window 200 includes a glass substrate 210 and a first coating layer 220.

The glass substrate 210 includes a glass, and it may be thin and bendable. For example, a thickness t1 of the glass substrate 210 may be equal to or less than 100 micrometers (μm). More specifically, the thickness t1 of the glass substrate 210 may be 10 to 100 μm. The glass substrate 210 may include a reinforced glass.

The first coating layer 220 is provided on a lower major surface (referred as a first major surface) of the glass substrate 210. The first coating layer 220 includes an epoxy silane and an oligomer. The oligomer may include at least one of an epoxy oligomer, a polyimine oligomer, and an acryl oligomer, for example. The epoxy oligomer may include an epoxy group at an end of the oligomer, the polyimine oligomer may include an imine group at the end of the oligomer, and the acryl oligomer may include an acryl group at the end of the oligomer.

The oligomer may be chemically bonded to the epoxy group of the epoxy silane. The epoxy group of the epoxy oligomer may be chemically bonded to the epoxy group of the epoxy silane, the imine group of the polyimine oligomer may be chemically bonded to the epoxy group of the epoxy silane, and the acryl group of the acryl oligomer may be chemically bonded to the epoxy group of the epoxy silane. The first coating layer 220 of the cover window 200 according to an exemplary embodiment includes an epoxy silane and an oligomer that may be chemically bonded to the epoxy group of the epoxy silane, thereby improving impact resistance of the cover window 200.

The oligomer may be linear or branch-type. The oligomer may include a mononuclear or polynuclear aromatic ring. An average molecular weight of the oligomer is about 300 grams per mol (g/mol) to about 5000 g/mol.

An oligomer with the average molecular weight of less than 300 g/mol has a monomer form and does not have sufficient elasticity. Therefore, when the oligomer with the average molecular weight of less than 300 g/mol is applied to the first coating layer 220, the first coating layer 220 may not have sufficient impact resistance. Further, when an oligomer with the average molecular weight of greater than 5000 g/mol, the molecular weight is very great, so it may not be manufactured by a thermal evaporation method. That is, the polymer with the average molecular weight of greater than 5000 g/mol may be carbonized before it is evaporated during the process for manufacturing the same using the thermal evaporation method.

In an exemplary embodiment of the invention, the average molecular weight of the oligomer may be 330 g/mol to 2000 g/mol. This represents a range in which the oligomer has sufficient elasticity and the coating layer is easily formed during the manufacturing process.

The first coating layer 220 may have a planar form with a substantially constant thickness, and the thickness t2 of the first coating layer 220 may be equal to or less than 1000 angstroms (Å). More specifically, the thickness t2 of the first coating layer 220 may be 50 to 1000 Δ. When the thickness of the first coating layer 220 is greater than 1000Δ, the entire thickness of the cover window 200 is increased to thus reduce a bendable characteristic. The first coating layer 220 may be deposited on the glass substrate 210 by a physical vapor deposition (“PVD”) method. The physical vapor deposition (PVD) method may be a thermal evaporation method or an electron beam (i.e., e-beam) evaporation method.

The cover window 200 includes a glass substrate 210 and a first coating layer 220. The thickness t1 of the glass substrate 210 may be equal to or less than 100 μm. As the glass substrate 210 is thin, the glass substrate 210 may be applied to the flexible display device.

That is, when the thickness of the glass substrate 210 is reduced to be several tens of micrometers, and the glass substrate 210 may be bendable. However, as the glass substrate 210 becomes thin, a risk of damage caused by external impacts increases.

The cover window 200 according to an exemplary embodiment of the invention includes a first coating layer 220 disposed on one major surface of the glass substrate 210. The first coating layer 220 may fill minute cracks or grooves formed in the glass substrate 210, and, therefore, may prevent the glass substrate 210 from being damaged. That is, minute cracks generated on the glass substrate 210 may work as a starting point of damage when external impacts are applied. However, the cover window 200 according to an exemplary embodiment of the invention may fill the minute cracks generated on the glass substrate 210 with the first coating layer 220 and may improve impact resistance of the thin film cover window 200.

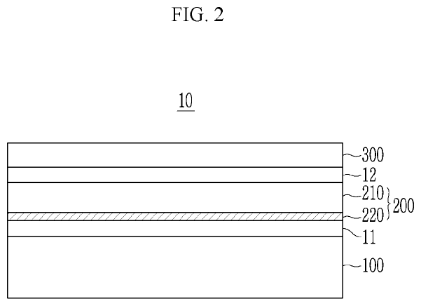

A display device according to an exemplary embodiment will now be described with reference to FIG. 2. FIG. 2 shows a cross-sectional view of a display device according to an exemplary embodiment.

Referring to FIG. 2, the display device 10 includes a display panel 100, a first adhesive layer 11, a cover window 200, a second adhesive layer 12, and a passivation film 300.

The display panel 100 may include a plurality of pixels displaying images, and it may be a flexible display panel. The display panel 100 may be a display panel of the liquid crystal display including a liquid crystal layer or the emissive display device including a light emitting diode (“LED”), for example. The display panel 100 may include a substrate, and a thin film transistor, a gate line, a data line, a pixel electrode, and a common electrode disposed on the substrate. The substrate of the display panel 100 may be a flexible substrate made of a plastic material with excellent heat resistance and durability such as polyethylene naphthalate (“PEN”), polycarbonate (“PC”), polyarylate (“PAR”), polyether imide (“PEI”), polyether sulfone (“PES”), polyimide (“PI”), and poly(methylmethacrylate) (“PMMA”), for example. Further, without being limited to this, the substrate of the display panel 100 may include various flexible materials in another exemplary embodiment. The display panel 100 may include a touch sensing layer (not shown) for sensing a touch of a user.

The first adhesive layer 11 and the cover window 200 are disposed on the display panel 100. The first adhesive layer 11 may be disposed between the display panel 100 and the cover window 200, and may attach the cover window 200 to the display panel 100.

The cover window 200 includes the glass substrate 210 and the first coating layer 220. The cover window 200 may be the cover window 200 of FIG. 1. The first coating layer 220 is disposed between the glass substrate 210 and the display panel 100. The cover window 200 may be disposed on the display panel 100 and may protect the display panel 100 from external impacts. The cover window 200 may be transparent so as to transmit the image displayed by the display panel 100.

The first coating layer 220 includes an epoxy silane and an oligomer. The oligomer may include at least one of the epoxy oligomer, the polyimine oligomer, and the acryl oligomer. An average molecular weight of the oligomer may be 300 g/mol to 5000 g/mol.

The second adhesive layer 12 and the passivation film 300 may be sequentially disposed on the cover window 200. The second adhesive layer 12 may be disposed between the cover window 200 and the passivation film 300, and may attach the passivation film 300 to the cover window 200.

The passivation film 300 may be disposed on the cover window 200, and may protect the display panel 100 from the external impacts together with the cover window 200. The passivation film 300 may be omitted in another exemplary embodiment.

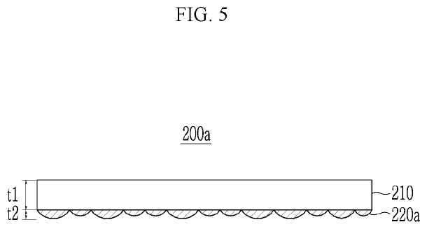

The display device 10 is illustrated in FIG. 2 to include the cover window 200 of FIG. 1. However, in another exemplary embodiment, the display device may include one of the cover windows of FIG. 5 to FIG. 11 instead of the cover window 200 of FIG. 1.

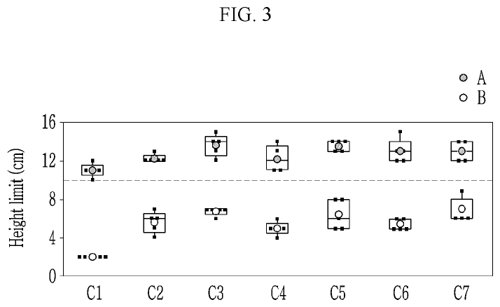

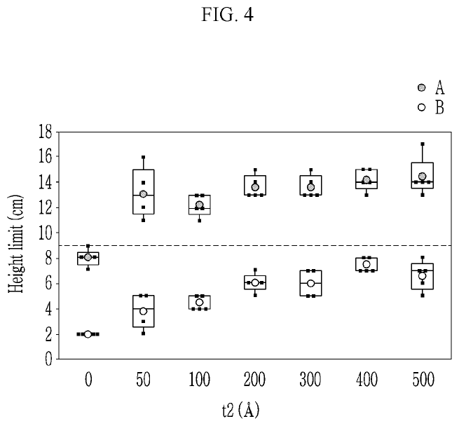

A height limit of free fall of a pen into the cover window according to exemplary embodiments will now be described with reference to FIGS. 3 and 4. FIG. 3 shows a graph of a height limit of free fall of a pen into a cover window without the first coating layer 220 according to a comparative example C1, and the cover windows 200 including the first coating layer 220 according to exemplary embodiments C2, C3, C4, C5, C6, and C7. The height limit of FIG. 3 refers to a maximum free fall height of a pen from which the cover window 200 is not broken and lasts when a pen freely falls onto the cover window 200.

In FIGS. 3 and 4, “A” represents a case in which a passivation film 300 of FIG. 2 is disposed on the cover window 200, and “B” represents a case in which the passivation film 300 is not disposed on the cover window 200.

C2, C3, C4, C5, C6, and C7 represent exemplary embodiments of the cover window 200 including a glass substrate 210 and a first coating layer 220 disposed on a lower major surface of the glass substrate 210. In detail, C2 represents an exemplary embodiment in which a coating layer includes a linear epoxy oligomer with an average molecular weight of 500 g/mol and an epoxy silane, C3 represents an exemplary embodiment in which a coating layer includes a linear epoxy oligomer with the average molecular weight of 350 g/mol and an epoxy silane, and C4 represents an exemplary embodiment in which a coating layer includes an epoxy silane and an epoxy oligomer, where the epoxy oligomer has the average molecular weight of 500 g/mol and includes an aromatic ring. C5 represents an exemplary embodiment in which a coating layer includes a linear polyimine oligomer with the average molecular weight of 500 g/mol and an epoxy silane, C6 represents an exemplary embodiment in which a coating layer includes a linear polyimine oligomer with the average molecular weight of 350 g/mol an epoxy silane, and C7 represents an exemplary embodiment in which a coating layer includes an epoxy silane and a polyimine oligomer, where the polyimine oligomer has the average molecular weight of 500 g/mol and includes an aromatic ring. Referring to FIG. 3, compared to the comparative example C1 without the first coating layer 220, it is found that the height limit of free fall of a pen into the cover window 200 according to the exemplary embodiments C2, C3, C4, C5, C6, and C7 has increased. That is, it is found that impact resistance of the cover window 200 is improved, and the cover window 200 is not broken but lasts against bigger impacts.

The height limit of free fall of a pen to the cover window according to the thickness t2 of the coating layer will now be described with reference to FIG. 4. FIG. 4 shows a graph of the height limit of the free fall of the pen to the cover window 200 according to a thickness t2 of a first coating layer 220. In this instance, “A” represents a case in which the passivation film 300 of FIG. 2 is disposed on the cover window 200, and “B” represents a case in which the passivation film 300 is not disposed on the cover window 200.

Referring to FIG. 4, compared to the case (i.e., t2=0) including no coating layer, it is found that the height limit has increased when t2 is 50 Å, 100 Å, 200 Å, 300 Å, 400 Å, or 500 Å. That is, it is found that impact resistance of the cover window 200 is improved, and the cover window 200 is not broken but lasts against bigger impacts. A cover window according to another exemplary embodiment will now be described with reference to FIG. 5. FIG. 5 shows a cross-sectional view of a cover window according to an exemplary embodiment.

Referring to FIG. 5, a cover window 200a includes a glass substrate 210 and a first coating layer 220a disposed on a lower major surface of the glass substrate 210. Differing from FIG. 1, the first coating layer 220a of the cover window 200a according to an exemplary embodiment of FIG. 5 may have a concave and convex shape having a plurality of protrusions.

When the first coating layer 220a has a concave and convex shape, a surface area of first the coating layer 220a is increased, and a buffering effect may be maximized. That is, when the first coating layer 220a has a concave and convex shape, compared to the case in which the coating layer is formed in a planar shape, its surface area becomes greater, so buffering performance of the cover window 200a is improved.

The first coating layer 220a includes an epoxy silane and an oligomer. The oligomer may include at least one of the epoxy oligomer, the polyimine oligomer, and the acryl oligomer. The average molecular weight of the oligomer may be 300 g/mol to 5000 g/mol.

The thickness t1 of the glass substrate 210 may be equal to or less than 100 μm. The thickness t2 of the first coating layer 220a may be 1000 Å. In this instance, the thickness t2 of the first coating layer 220 having a concave and convex shape may refer to the maximum thickness of the first coating layer 220.

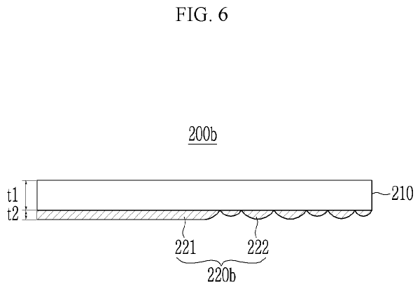

Referring to FIG. 6, a cover window according to still another exemplary embodiment will now be described. FIG. 6 shows a cross-sectional view of a cover window according to still another exemplary embodiment.

Referring to FIG. 6, the cover window 200b includes a glass substrate 210, and a first coating layer 220b disposed on the lower major surface of the glass substrate 210. The first coating layer 220b includes an epoxy silane and an oligomer. The oligomer may include at least one of the epoxy oligomer, the polyimine oligomer, and the acryl oligomer. The average molecular weight of the oligomer may be 300 g/mol to 5000 g/mol.

Differing from FIG. 1, the first coating layer 220b of the cover window 200b according to an exemplary embodiment described with reference to FIG. 6 includes a planar coating layer 221 having a substantially constant thickness, and a protrusions and depressions coating layer 222 having a concave and convex shape. The planar coating layer 221 and the protrusions and depressions coating layer 222 may be disposed in the same layer, may include a same material, and may be simultaneously formed.

When the first coating layer 220b include both the planar coating layer 221 and the protrusions and depressions coating layer 222, the entire surface area of the first coating layer 220b increases by the protrusions and depressions coating layer 222, thereby further improving the buffering performance.

The thickness t1 of the glass substrate 210 may be equal to or less than 100 μm. The thickness t2 of the first coating layer 220b may be equal to or less than 1000 Å. As the glass substrate 210 is formed to be thin, the glass substrate 210 may be well bent and may be applied to the flexible display device. The first coating layer 220b disposed on the glass substrate 210 may increase impact resistance of the glass substrate.

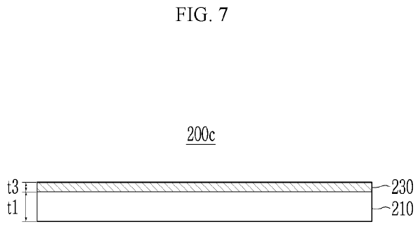

A cover window according to yet another exemplary embodiment will now be described with reference to FIG. 7. FIG. 7 shows a cross-sectional view of a cover window according to yet another exemplary embodiment.

Referring to FIG. 7, the cover window 200c includes a glass substrate 210, and a second coating layer 230 disposed on the upper major surface (referred as a second major surface) of the glass substrate 210. That is, regarding the display device, the second coating layer 230 may be disposed on the upper major surface of the glass substrate 210, and the display panel may be disposed on the lower major surface of the glass substrate 210.

The second coating layer 230 includes an epoxy silane and an oligomer. The oligomer includes at least one of the epoxy oligomer, the polyimine oligomer, and the acryl oligomer. The average molecular weight of the oligomer may be 300 g/mol to 5000 g/mol.

The second coating layer 230 of the cover window 200c according to an exemplary embodiment of FIG. 7 may have a planar shape with a substantially constant thickness. In this instance, the thickness t1 of the glass substrate 210 may be equal to or less than 100 μm. The thickness t3 of the second coating layer 230 may be equal to or less than 1000 Å.

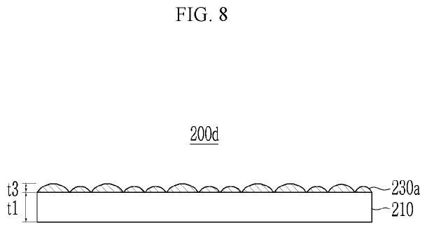

A cover window according to still another exemplary embodiment will now be described with reference to FIG. 8. FIG. 8 shows a cross-sectional view of a cover window according to still another exemplary embodiment.

Referring to FIG. 8, the cover window 200d includes a glass substrate 210 and a second coating layer 230a disposed on the upper major surface (second major surface) of the glass substrate 210. That is, regarding the display device, the second coating layer 230 may be disposed on the upper major surface of the glass substrate 210, and the display panel may be disposed on the lower major surface of the glass substrate 210.

The second coating layer 230a includes an epoxy silane and an oligomer. The oligomer may include at least one of the epoxy oligomer, the polyimine oligomer, and the acryl oligomer. The average molecular weight of the oligomer may be 300 g/mol to 5000 g/mol.

The second coating layer 230a of the cover window 200d according to an exemplary embodiment described with reference to FIG. 8 may have a concave and convex shape including a plurality of protrusions. In this instance, the thickness t1 of the glass substrate 210 may be equal to or less than 100 μm. The thickness t3 of the second coating layer 230a may be equal to or less than 1000 Å.

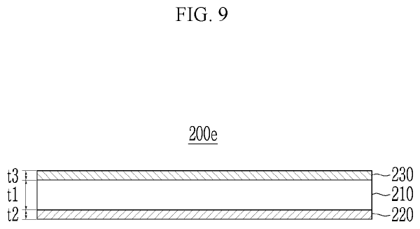

A cover window according to yet another exemplary embodiment will now be described with reference to FIG. 9. FIG. 9 shows a cross-sectional view of a cover window according to yet another exemplary embodiment.

Referring to FIG. 9, the cover window 200e includes a glass substrate 210, a first coating layer 220 disposed on the lower major surface (first major surface) of the glass substrate 210, and a second coating layer 230 disposed on the upper major surface (second major surface) of the glass substrate 210 facing the lower major surface. The first coating layer 220 and the second coating layer 230 may have a planar form with a substantially constant thickness.

The first coating layer 220 and the second coating layer 230 include an epoxy silane and an oligomer. The oligomer may include at least one of the epoxy oligomer, the polyimine oligomer, and the acryl oligomer. The average molecular weight of the oligomer may be 300 g/mol to 5000 g/mol. The first coating layer 220 and the second coating layer 230 may include the same material. However, in another exemplary embodiment, the first coating layer 220 and the second coating layer 230 may include different materials from each other.

The thickness t1 of the glass substrate 210 may be equal to or less than 100 μm. The thickness t2 of the first coating layer 220 and the thickness t3 of the second coating layer 230 may be equal to or less than 1000 Å, respectively.

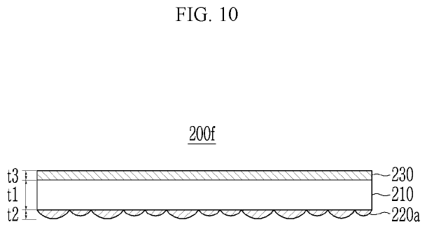

A cover window according to still another exemplary embodiment will now be described with referring to FIG. 10. FIG. 10 shows a cross-sectional view of a cover window according to still another exemplary embodiment.

Referring to FIG. 10, the cover window 200f includes a glass substrate 210, a first coating layer 220a disposed on the lower major surface (first major surface) of the glass substrate 210, and a second coating layer 230 disposed on the upper major surface (second major surface) of the glass substrate 210 facing the lower major surface. The second coating layer 230 may have a planar shape with a substantially constant thickness, and the first coating layer 220a may have a concave and convex shape including a plurality of protrusions.

The first coating layer 220a and the second coating layer 230 include an epoxy silane and an oligomer. The oligomer may include at least one of the epoxy oligomer, the polyimine oligomer, and the acryl oligomer. The average molecular weight of the oligomer may be 300 g/mol to 5000 g/mol. The first coating layer 220a and the second coating layer 230 may include the same material. However, in another exemplary embodiment, the first coating layer 220 and the second coating layer 230 may include different materials from each other.

The thickness t1 of the glass substrate 210 may be equal to or less than 100 μm. The thickness t2 of the first coating layer 220 and the thickness t3 of the second coating layer 230 may be equal to or less than 1000 Å, respectively.

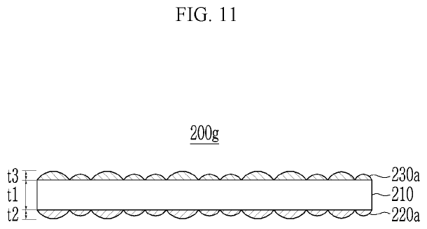

A cover window according to yet another exemplary embodiment will now be described with reference to FIG. 11. FIG. 11 shows a cross-sectional view of a cover window according to yet another exemplary embodiment.

Referring to FIG. 11, the cover window 200g includes a glass substrate 210, a first coating layer 220a disposed on the lower major surface (first major surface) of the glass substrate 210, and a second coating layer 230a disposed on the upper major surface (second major surface) of the glass substrate 210 facing the lower major surface. Each of the first coating layer 220a and the second coating layer 230a may have a concave and convex shape including a plurality of protrusions.

The first coating layer 220a and the second coating layer 230a include an epoxy silane and an oligomer. The oligomer may include at least one of the epoxy oligomer, the polyimine oligomer, and the acryl oligomer. The average molecular weight of the oligomer may be 300 g/mol to 5000 g/mol. The first coating layer 220a and the second coating layer 230a may have the same material. However, 9n another exemplary embodiment, the first coating layer 220 and the second coating layer 230 may include different materials from each other.

The thickness t1 of the glass substrate 210 may be equal to or less than 100 μm. The thickness t2 of the first coating layer 220a and the thickness t3 of the second coating layer 230a may be respectively equal to or less than 1000 Å, respectively.

While this invention has been described in connection with what is presently considered to be practical exemplary embodiments, it is to be understood that the invention is not limited to the disclosed exemplary embodiments, but, on the contrary, is intended to cover various modifications and equivalent arrangements included within the spirit and scope of the appended claims.

### DESCRIPTION OF SYMBOLS

| | |
|---|---|
| 10: display device | 100: display panel |
| 11: first adhesive layer | 12: second adhesive layer |
| 200: cover window | 210: glass substrate |
| 220, 230: coating layer | 221: planar coating layer |
| 222: protrusions and | 300: passivation film |
| depressions coating layer | |

What is claimed is:

1. A cover window comprising:
a glass substrate; and
a first coating layer disposed on a first major surface of the glass substrate,
wherein the first coating layer includes an epoxy silane and an oligomer, and
an average molecular weight of the oligomer is about 300 grams per mol (g/mol) to about 5000 grams per mol (g/mol).

2. The cover window of claim 1, wherein
the average molecular weight of the oligomer is about 330 grams per mol (g/mol) to about 2000 grams per mol (g/mol).

3. The cover window of claim 1, wherein
a thickness of the glass substrate is 10 to 100 micrometers (μm).

4. The cover window of claim 1, wherein
the oligomer includes a polyimine oligomer.

5. The cover window of claim 1, wherein
the oligomer includes an epoxy oligomer or an acryl oligomer.

6. The cover window of claim 1, wherein
a thickness of the first coating layer is 50 to 1000 angstroms (Å).

7. The cover window of claim 1, wherein
the oligomer is linear.

8. The cover window of claim 1, wherein
the oligomer includes an aromatic ring.

9. The cover window of claim 1, wherein
the first coating layer has a constant thickness.

10. The cover window of claim 1, wherein
the first coating layer has a concave and convex shape including a plurality of protrusions.

11. The cover window of claim 10, further comprising
a second coating layer disposed on a second major surface facing the first major surface of the glass substrate,
wherein the second coating layer includes an epoxy silane and an oligomer, and
an average molecular weight of the oligomer is about 300 grams per mol (g/mol) to about 5000 grams per mol (g/mol).

12. A display device comprising:
a display panel; and
a cover window disposed on the display panel,
wherein the cover window includes
a glass substrate, and
a first coating layer disposed on a first major surface of the glass substrate,
the first coating layer includes an epoxy silane and an oligomer, and
an average molecular weight of the oligomer is about 300 grams per mol (g/mol) to about 5000 grams per mol (g/mol).

13. The display device of claim 12, wherein
the average molecular weight of the oligomer is about 330 grams per mol (g/mol) to about 2000 grams per mol (g/mol).

14. The display device of claim 12, wherein
a thickness of the glass substrate is 10 to 100 micrometers (μm).

15. The display device of claim 12, wherein
the oligomer includes a polyimine oligomer.

16. The display device of claim 12, wherein
the oligomer includes an epoxy oligomer or an acryl oligomer.

17. The display device of claim 12, wherein
a thickness of the first coating layer is 50 to 1000 angstroms (Å).

18. The display device of claim 12, wherein
the cover window further includes a second coating layer disposed on a second major surface facing the first major surface of the glass substrate,
the second coating layer includes an epoxy silane and an oligomer, and
an average molecular weight of the oligomer is about 300 grams per mol (g/mol) to about 5000 grams per mol (g/mol).

19. The display device of claim 18, wherein
the first coating layer has a constant thickness, and
the second coating layer has a concave and convex shape including a plurality of protrusions.

20. The display device of claim 19, wherein
the first coating layer and the second coating layer include different materials from each other.
